(19) United States
(12) Patent Application Publication
(10) Pub. No.: US 2025/0076254 A1
(43) Pub. Date: Mar. 6, 2025

(54) METHOD TO ENHANCE SENSITIVITY OF MULTI-CASING CORROSION MEASUREMENT

(71) Applicant: Baker Hughes Oilfield Operations LLC, Houston, TX (US)

(72) Inventors: Sushant Dutta, Sugar Land, TX (US); Marc Ramirez, Missouri City, TX (US); Andrew Smith, Alton (GB); Jun Zhang, Katy, TX (US)

(73) Assignee: Baker Hughes Oilfield Operations LLC, Houston, TX (US)

(21) Appl. No.: 18/819,774

(22) Filed: Aug. 29, 2024

Related U.S. Application Data
(60) Provisional application No. 63/535,980, filed on Aug. 31, 2023.

(51) Int. Cl. G01N 27/90

(52) U.S. Cl. CPC G01N 27/9046

(57) ABSTRACT

Disclosed herein is a wellbore casing corrosion measurement tool, including a sensor assembly and control circuitry. The control circuitry is configured to energize selected components of the sensor assembly to produce multiple electromagnetic fields that are arranged about a circumference of the sensor assembly to induce eddy currents in at least one wellbore casing string, and detect magnetic fields resulting from the eddy currents in the at least one wellbore casing string via the sensor assembly, said magnetic fields being indicative of a state of the at least one wellbore casing string.

### RELATED APPLICATION

This application claims priority to United States Provisional Application for Patent No. 63/535,980, filed Aug. 31, 2023, the contents of which are incorporated by reference in their entirety.

### TECHNICAL FIELD

This disclosure is related to the field of detection and measurement of wellbore casing corrosion utilizing tools with electromagnetic based sensors.

### BACKGROUND

Oil and gas wells are heavily utilized in meeting the worldwide energy demand. The structural integrity and safe operation of these wells relies on casing systems, which are designed to prevent the wellbore from caving in, isolate different layers of the subsurface formation, and prevent intermixing of fluids from different zones. As oil and gas wells age, different casing strings at different levels of the well, such as the conductor casing string, surface casing string, intermediate casing string, and production casing string, may experience degradation due to corrosion, erosion, or other factors.

The conductor casing string provides initial structural support during the drilling process and prevents erosion of shallow soil layers. The surface casing string is subsequently installed within the conductor casing to provide for isolation of freshwater zones and provide a solid foundation for blowout prevention equipment to control pressure during the drilling of subsequent sections. The intermediate casing string is installed next, within the surface casing string, and is designed to isolate unstable sections of the borehole and guard against incursion of fluids from high-pressure zones. Finally, the production casing string is placed within the intermediate casing string to isolate production zones and contain produced hydrocarbons. Given their crucial roles, reliable and cost-effective methods to assess the condition of these casing strings are of value to determine when intervention or workover is necessary.

Several commercial tools exist to determine the condition of casing strings, such as by assessing metal loss or gain percentage. However, certain of these tools have significant limitations as they only provide circumferentially averaged measurements, which means the measurements are averaged over the entire 360 degrees around the tool's sensitivity axis. While this provides a general measure of casing condition over the entire circumference, it fails to provide detailed azimuthal information—in this context, “azimuthal” refers to data that provides insight into the condition of the casing string at each distinct point along its entire 360-degree circumference in the localized region of the casing string being sensed by the tool.

This averaging approach utilized by the aforementioned tools leads to a significant limitation in that it fails to offer a comprehensive understanding of the casing's condition. For example, these tools may be unable discern between a uniform 20% metal loss throughout the entire circumference of a casing string and a 100% metal loss feature confined to a 72-degree sector of the same casing string. The former case suggests a casing potentially requiring no immediate intervention, whereas the latter indicates a catastrophic failure warranting immediate action.

It is desired for commercial tools, such as magnetic flux leakage, ultrasonic pulse-echo, and pulsed eddy current based tools to be able to provide azimuthal information for at least the production casing string. Therefore, further development is needed in order to device an improved method or system capable of providing accurate azimuthal information on the condition of at least the production casing, and in some cases also the subsequent casing strings, in oil and gas wells. These improvements would enable operators to make informed decisions regarding well maintenance and intervention.

### SUMMARY

Disclosed herein is a wellbore casing corrosion measurement tool that includes a sensor assembly and control circuitry. The control circuitry is configured to energize selected components of the sensor assembly to produce multiple electromagnetic fields that are arranged about a circumference of the sensor assembly to induce eddy currents in at least one wellbore casing string. The control circuitry is also configured to detect magnetic fields resulting from the eddy currents in the at least one wellbore casing string via the sensor assembly, said magnetic fields being indicative of a state of the at least one wellbore casing string.

The selected components of the sensor assembly may be energized to produce multiple radially outwardly extending electromagnetic fields that are arranged about a circumference of the sensor assembly to induce eddy currents in at least one wellbore casing string. These electromagnetic fields may be symmetrically arranged about the circumference of the sensor assembly.

The detection of magnetic fields resulting from the eddy currents in the at least one wellbore casing string via the sensor assembly may involve detecting variations in magnetic fields resulting from the eddy currents, with these variations being indicative of a state of the at least one wellbore casing string.

The sensor assembly may include a plurality of sensor segments arranged into a segmented cylindrical shape such that a sensitivity axis of each sensor segment is aligned along a radial direction. The electromagnetic fields may be formed by simultaneously energizing multiple opposing sensor segments or multiple groups of opposing sensor segments.

The control circuitry may be further configured to change the selected components of the sensor assembly being energized over time to shift focus of the electromagnetic fields to investigate different azimuthal sectors of the at least one wellbore casing string via the sensor assembly.

The sensor assembly may include multiple groups of sensor segments, each group configured to generate an electromagnetic field. Each group may include first and second sets of sensor segments positioned radially opposite from one another about the circumference of the sensor assembly. Magnetic fields generated by the first and second sets of sensor segments within each group when energized by the control circuitry may have propagation directions oriented toward one another, forming a net magnetic field that extends from that group to form one of the electromagnetic fields that induces eddy currents in the at least one wellbore casing string. The first and second sets of sensor segments may be positioned radially opposite from one another about the circumference of the sensor assembly in an antiparallel manner.

The control circuitry may be further configured to change which groups of sensor segments are energized over time, thereby shifting focus of the electromagnetic fields about a circumference of the sensor assembly to investigate different azimuthal sectors of the at least one wellbore casing string via the sensor assembly.

The sensor assembly may include multiple groups of sensor segments, each group organized in a segmented cylindrical shape. Within each group, the sensor segments may alternate between having their sensitivity axes aligned along a circumferential direction, forming a Halbach array configuration. The control circuitry may be configured to energize transmitter coils at a selected sequence of the sensor segments within each group such that, due to the Halbach array configuration, the energized sequence creates a magnetic field extending from a central sensor segment of the sequence to generate one of the electromagnetic fields that induces eddy currents in the at least one wellbore casing string.

A method for assessing a condition of at least one wellbore casing string using a wellbore casing corrosion measurement tool includes deploying the tool into the at least one wellbore casing string, the tool having a sensor assembly. The method involves energizing selected components of the sensor assembly to produce multiple electromagnetic fields that are arranged about a circumference of the sensor assembly to induce eddy currents in the at least one wellbore casing string with the produced electromagnetic fields. The method also includes detecting a magnetic field generated by the eddy currents in the at least one wellbore casing string over time via selected ones of the components of the sensor assembly, recording the detected magnetic field, and analyzing the recorded rate of change to determine potential conditions of the at least one wellbore casing string based on the detected rate of change.

The energizing of the selected components of the sensor assembly may produce multiple radially outwardly extending electromagnetic fields that are arranged about a circumference of the sensor assembly to induce eddy currents in the at least one wellbore casing string with the produced magnetic fields. These electromagnetic fields may be symmetrically arranged about the circumference of the sensor assembly.

The detection of the magnetic field may involve detecting a rate of change in the magnetic field by the eddy currents in the at least one wellbore casing string over time via selected ones of the components of the sensor assembly.

The electromagnetic fields may be formed by simultaneously energizing multiple opposing sensor segments of the sensor assembly or multiple groups of opposing sensor segments of the sensor assembly.

The method may further include changing the selected components of the sensor assembly being energized over time to shift focus of the electromagnetic fields about circumference of the sensor assembly to investigate different azimuthal sectors of the at least one wellbore casing string.

Energizing the selected components of the sensor assembly may involve generating electromagnetic fields from multiple selected groups of sensor segments of the sensor assembly by causing each selected group to generate magnetic fields at first and second sets of sensor segments within that selected group to have propagation directions oriented toward one another, forming a net magnetic field that extends radially outwardly from that selected group to form one of the electromagnetic fields that induces eddy currents in the at least one wellbore casing string.

Energizing the selected components of the sensor assembly may involve generating electromagnetic fields from multiple selected groups of sensor segments of the sensor assembly by causing each selected group to energize transmitter coils at a chosen sequence of the sensor segments within that selected group arranged in a Hallbach array configuration to produce a magnetic field extending from a central sensor segment of the Hallbach array configuration, thereby creating one of the electromagnetic fields that induces eddy currents in the at least one wellbore casing string.

### BRIEF DESCRIPTION OF THE DRAWINGS

FIG. 1 is a diagrammatical view of a wellsite with a casing system installed in the wellbore, with a casing corrosion measurement tool being lowered into the wellbore via a wireline.

FIG. 2A is a perspective view of an electromagnetic sensor disclosed herein for performing casing corrosion measurements.

FIG. 2B is a top view of the sensor of FIG. 2A.

FIG. 2C is an enlarged perspective view of a segment of the sensor of FIG. 1A.

FIG. 3A is a perspective view of another electromagnetic sensor disclosed herein for performing casing corrosion measurements.

FIG. 3B is a top view of the sensor of FIG. 3A.

FIG. 3C is an enlarged perspective view of the sensor of FIG. 3A.

FIG. 4 is a graph comparing the signal-to-noise ratio (SNR) of the sensor of FIG. 3A to the sensor of FIG. 2A.

FIG. 5A is a perspective view of a further electromagnetic sensor disclosed herein for performing casing corrosion measurements.

FIG. 5B is a top view of the sensor of FIG. 5A.

FIG. 5C is an enlarged perspective view of the sensor of FIG. 5A.

FIG. 6A is a perspective view of a sensor assembly including the sensor of FIG. 2A together with adjacent single core solenoids.

FIG. 6B is a perspective view of a sensor assembly including the sensor of FIG. 2A together with adjacent segmented solenoids.

FIG. 7A is a perspective view of a sensor assembly including the sensor of FIG. 3A together with adjacent single core solenoids.

FIG. 7B is a perspective view of a sensor assembly including the sensor of FIG. 3A together with adjacent segmented solenoids.

FIG. 8 is a diagrammatical representation of a sensor assembly including the sensor of FIG. 2A, 3A, 5A, 6A, 6B, 7A, or 7B operated according to a first firing technique.

FIG. 9 is a diagrammatical representation of a sensor assembly including the sensor of FIG. 2A, 3A, 5A, 6A, 6B, 7A, or 7B operated according to a second firing technique.

FIG. 10 is a graph showing sensitivity of a sensor assembly including the sensor of FIG. 2A, 3A, 5A, 6A, 6B, 7A, or 7B when operated according to the first firing technique of FIG. 8 to detect flaws.

FIG. 11 is a graph showing sensitivity of a sensor assembly including the sensor of FIG. 2A, 3A, 5A, 6A, 6B, 7A, or 7B when operated according to the second firing technique of FIG. 9 to detect flaws.

FIG. 12 is a graph showing sensitivity of a sensor assembly including the sensor of FIG. 2A, 3A, 5A, 6A, 6B, 7A, or 7B when operated according to the first firing technique of FIG. 8 to detect flaws.

FIG. 13 is a graph showing sensitivity of a sensor assembly including the sensor of FIG. 2A, 3A, 5A, 6A, 6B, 7A, or 7B when operated according to the second firing technique of FIG. 9 to detect flaws.

FIG. 14 is a diagrammatical representation of a sensor assembly including the sensor of FIG. 2A, 3A, 5A, 6A, 6B, 7A, or 7B operated according to a variation of the second firing technique of FIG. 9.

FIG. 15 is a diagrammatical representation of a sensor assembly including the sensor of FIG. 2A, 3A, 5A, 6A, 6B, 7A, or 7B operated according to another variation of the second firing technique of FIG. 9.

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

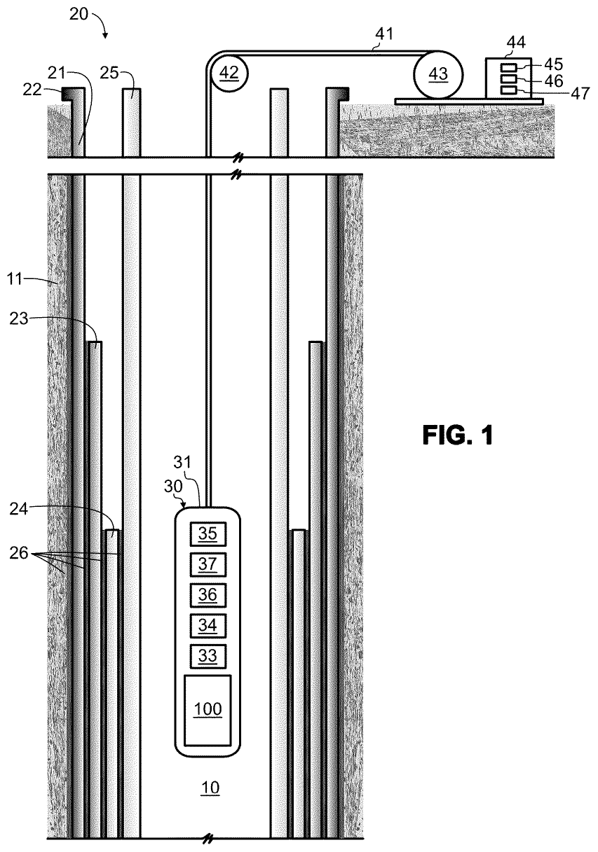

Shown in FIG. 1 is a cross-sectional view of a subsurface formation 11 having a wellbore 10 formed therein, with a casing system 20 installed within the wellbore 10. A corrosion measurement tool 30 is located within the casing system 20 for the purpose of conducting casing corrosion measurements.

The casing system 20 includes three concentric casing strings. Adjacent to the surface of the wellbore 10 is a conductor casing string 21. At the upper end of the conductor casing string 21, hangars 22 are positioned to secure the casing system 20, thus preventing it from moving downward into the formation 11. Any component suitable for bearing the weight of the casing system 20 may serve as the hanger 22.

Within the conductor casing string 21 is a surface casing string 23. The diameter of the conductor casing string 21 is larger than that of the surface casing string 23. Inside the surface casing string 23, an intermediate casing string 24 is positioned. The diameter of the surface casing string 23 exceeds that of the intermediate casing string 24.

During the drilling and casing installation process, sealing members or wipers (not shown) may be arranged in the annular spaces between the conductor casing string 21 and the surface casing string 23, or between the surface casing string 23 and the intermediate casing string 24. These elements help prevent the migration of undesired solids into these annular spaces. Once the casing strings are properly positioned, cement 26 is injected into the annular space between the casing strings, and between the outer casing string and the wellbore. The cement 26 serves to stabilize the casing strings and isolate different zones in the well, preventing the intermixing of fluids from different formations.

A production casing string 25 is connected to the inner diameter of the intermediate casing string 24, and cement may be injected into the annual space therebetween. This casing string 25 provides structural support and acts as a conduit for various tools and fluids during operations.

The casing corrosion measurement tool 30 is illustrated as being lowered into and suspended in the wellbore 10 by a wireline 41 that extends from the surface. To guide the wireline towards the wireline spool 43 for retrieval, a sheave 42 is used to redirect its path as it exits the borehole. Surface equipment 44 controls the lowering and raising action of the wireline 41. Incorporated within the surface equipment 44 is a communication device 45 that facilitates bidirectional communication between the surface equipment 44 and the casing corrosion measurement tool 30. The communication device 45 transmits commands from the surface equipment 44 to the casing corrosion measurement tool 30, and also receives data from the casing corrosion measurement tool 30.

In addition to the communication device 45, the surface equipment 44 includes a data processing system 46. This system is responsible for processing the raw data received from the tool 30. For instance, the data processing system 46 can compute corrosion measurements from the received data, and subsequently visualize these measurements in a format comprehensible to an operator. A power supply system 47 is housed within the surface equipment 44 to supply power to the surface equipment 44, and, dependent upon whether the casing corrosion measurement tool 30 has a battery, may also transmit power down to the casing corrosion measurement tool 30 via the wireline 41.

An operator interface, which may be a computer terminal, allows operators to send commands to the casing corrosion measurement tool 30, visualize the data received from the data processing system 46, and monitor the overall operation, thereby providing control over the corrosion measurement process.

The casing corrosion measurement tool 30 houses several components within a mechanical housing 31. The mechanical housing 31 provides both structural integrity and environmental protection for the electronics and other components therein, thereby enabling the casing corrosion measurement tool 30 to withstand the harsh wellbore conditions.

Housed within the mechanical housing 31 is an electromagnetic sensor 100, which plays a direct role in performing casing corrosion measurements. The sensor 100 is constructed from segmented electromagnetic sensing elements, the specifics of which will be detailed subsequently below. An excitation source 33, also contained within the mechanical housing 31, is responsible for energizing the sensor 100 through the generation of time-varying electrical currents.

A controller or processor 34, housed within the mechanical housing 31, manages the operation of the sensor 100 and the excitation source 33. This component coordinates the timing of measurements and controls the operations of other components. It may further process the raw data collected by the sensor 100.

The power supply 35, located within the mechanical housing 31, provides power to the various components of the casing corrosion measurement tool 30. It can take the form of a battery pack or receive input power through a power line connected to the surface.

A data acquisition system 36 within the mechanical housing 31 captures, digitizes, and stores data generated by the sensor 100. This data can be optionally processed by the controller or processor 34, as explained above. The data acquisition system 36 may be integrated within the controller or processor 34.

Finally, a communication system 37 is incorporated within the mechanical housing 31. It enables the tool 30 to send the acquired data to the surface via a wireline 41 and receive commands from operators situated at the surface.

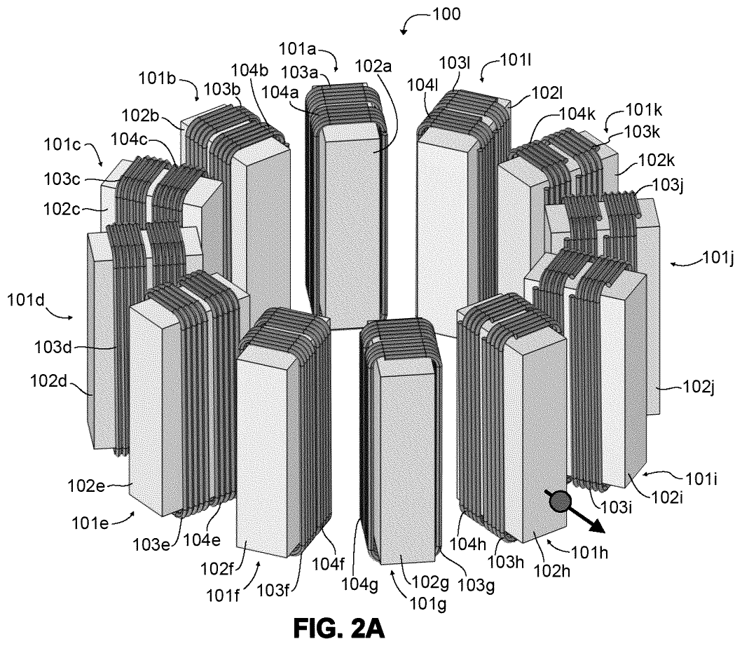

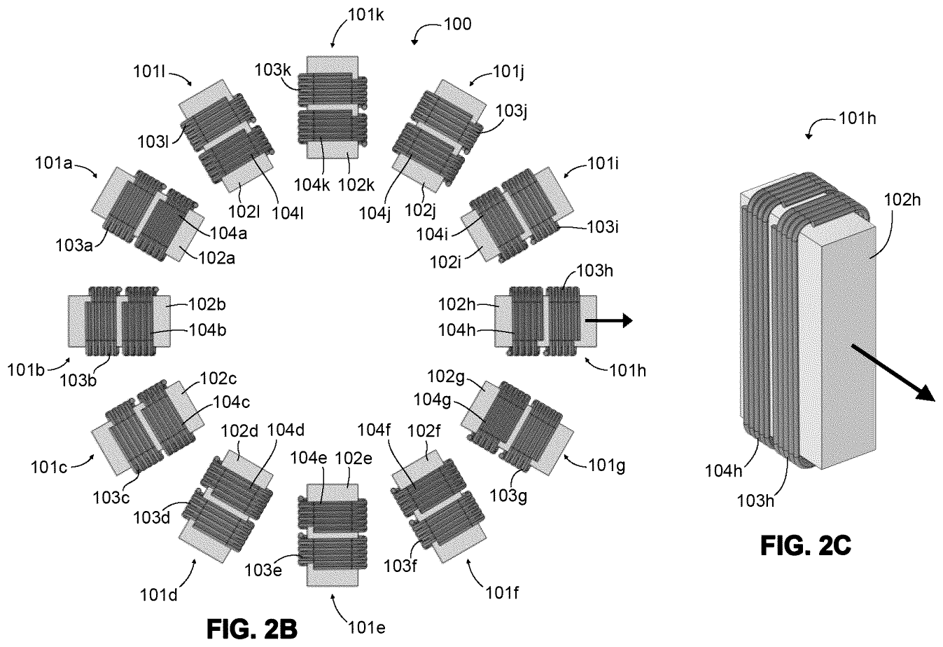

One embodiment of a sensor 100 capable of providing azimuthal information on the condition of the production casing 23 is now described with reference to FIG. 2A, showing a perspective view of the sensor 100, FIG. 2B, showing an overhead view of the sensor 100, and FIG. 2C, showing a greatly enlarged perspective view of the sensor 100. This sensor 100 comprises multiple discrete sensor segments 101a to 101l arranged radially around the circumference of the sensor 100.

In the illustrated example, each sensor segment 101a-101l includes a magnetic core 102a-102l, around which two coil windings, 103a-103l and 104a-104l, are wound; as an alternative, each sensor segment 101a-101l may include the coil windings 103a-103l and 104a-104l without the associated magnetic core 102a-102l. In this configuration, windings 103a-103l may function as transmitters, while windings 104a-104l serve as receivers; conversely, windings 103a-103l may function as receivers while windings 104a-104l function as transmitters. Still further, the illustrated coil windings 103a-103l and 104a-104l may be connected as part of a single coil to form transceivers, for example, transceivers 103a/104a-103l/104l.

The arrow in FIG. 2A symbolizes the sensitivity axis of sensor segment 101h, indicating the direction in which the segment 101h is most receptive to changes in the electromagnetic field.

During operation, each sensor segment, from 101a to 101l, is sequentially energized. As a specific example of operation of one sensor segment, in FIG. 2A, the currently energized segment, highlighted by a dot, is 101h. This segment actively transmits and receives electromagnetic signals for casing condition assessment. Specifically, when energized, transmitter winding 103h generates a steady or time-varying electromagnetic field that is applied to the casing. This electromagnetic field interacts with the casing, thereby inducing eddy currents whose attributes are reflective of the casing condition. Subsequently, receiver winding 104h detects the electromagnetic field resulting from these eddy currents. For example, by measuring the decay of these eddy currents over time based upon the electromagnetic field resulting therefrom, the condition of the azimuthal sector of the casing string covered by the sensor segment 101h can be determined. Through sequentially using each sensor segment 101a to 101h to make such measurements, a complete azimuthal measurement of the casing string may be obtained.

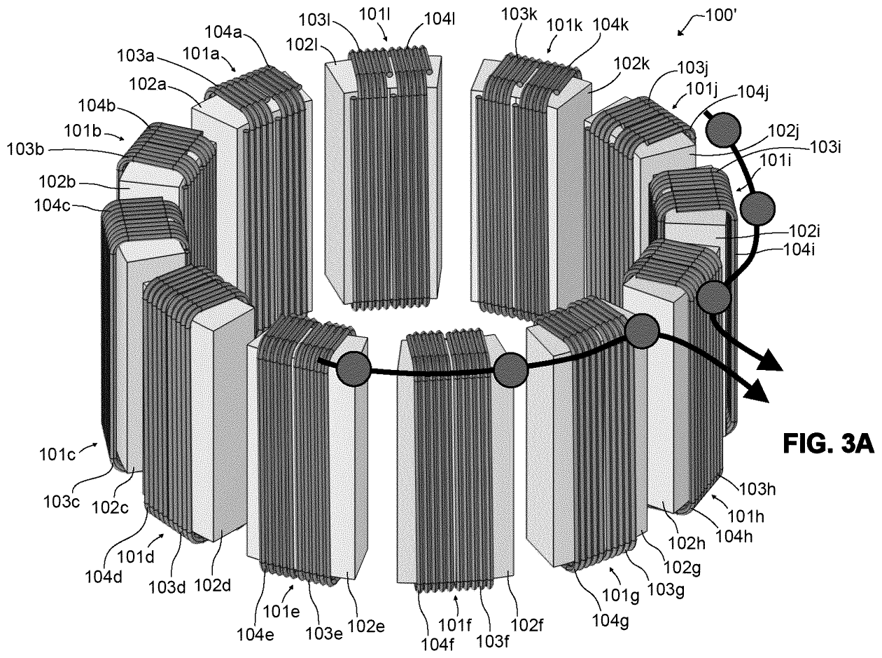

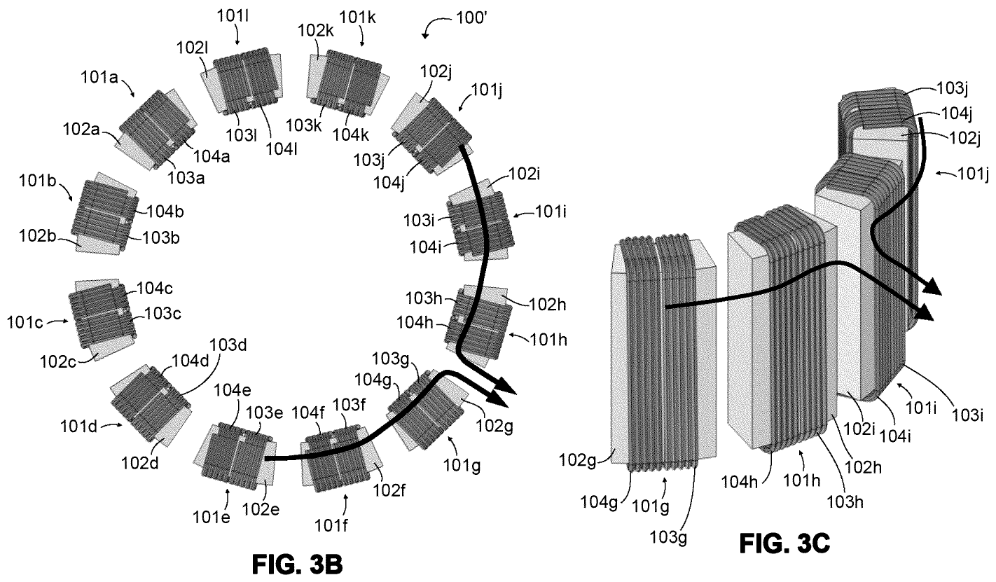

Details of one embodiment of the sensor 100′ capable of providing accurate azimuthal information about not only the production casing string 25 but also the subsequent casing strings are now given. The sensor 100′, as illustrated in perspective view in FIG. 3A the top view of FIG. 3B, and the enlarged perspective view of FIG. 3C, includes a plurality of sensor segments 101a-101i. In the illustrated example, each of the segments 101a-101l includes a magnetic core 102a-102l, with two coil windings 103a-103l and 104a-104l wrapped around each magnetic core; as an alternative, each segment 101a-101l may include coil windings 103a-103l and 104a-104l without the magnetic core 102a-102l. The coil windings 103a-103l may function as transmitters, and the coil windings 10a-1041 operate as receivers; conversely, windings 103a-103l may function as receivers while coil windings 104a-104l function as transmitters.

As an alternative, the illustrated coil windings 103a-103l and 104a-104l may be connected as part of a single coil to form transceivers, for example, transceivers 103a/104a-103l/104l.

In another example, the coil windings acting as transmitters (e.g., 103a-103l) may each be split into two pieces disposed on opposite sides of the coil windings acting as receivers (e.g., 104a-104l), with the coil windings acting as receivers being centrally located along the axis of the magnetic core 102a-102l; conversely, the coil windings acting as receivers (e.g., 104a-104l) may be split into two pieces disposed on opposite sides of the coil windings acting as transmitters (e.g., 103a-103l), with the coil windings acting as transmitters being centrally located along the axis of the magnetic core 102a-102l.

The sensor 100′ of FIGS. 3A-3C departs from the outward-pointing configuration of sensor segments 101a-101l of the sensor 100 of FIGS. 2A-2C and instead utilizes a formation where the arrangement of the sensor segments 101a-101l leads to the sensitivity axis of each segment being aligned along the circumferential/tangential direction, as opposed to the radially outward direction as in the conventional sensor of FIGS. 2A and 2B.

Despite the circumferential or tangential orientation of the sensitivity axis of each segment 101a-101l, the sensor 100′ described herein has a radially oriented sensitivity which can be steered. This results from a mode of activation where a number (e.g., an even number) of segments are energized in an opposing/antiparallel manner. Consider, for example, the opposing sets of segments 101e-101g and 101a-101j, as illustrated in FIGS. 3A-3B. When supplied with currents from the excitation source 33, these sets of segments 101e-101g and 101h-101j generate respective magnetic fields. Due to their positioning opposite each other around the circumference of the sensor 100′, segments 101e-101g and segments 101h-101j generate magnetic fields that interact to produce a radially outwardly extending magnetic field.

In greater detail, a first arrow depicted in FIG. 3A originates from segment 101e and follows a circumferential path around the sensor 100′ in a counterclockwise direction toward segment 101h, at which point the direction of the arrow deviates, extending radially outwardly. Similarly, another arrow is depicted as originating from segment 101j, extending circumferentially around the sensor 100′ in a clockwise direction toward segment 101g, where it also extends radially outwardly.

These arrows in FIG. 3A represent the primary directional behavior of the magnetic fields generated by these segments 101e-101g and 101h-101j when energized. In particular, each arrow represents the magnetic field propagation direction when the segment at its base is energized. When energized in an antiparallel manner as described, the resulting magnetic fields from segments 101e-101g and 101h-101j interact (which can be thought of as pushing on one another) to form a net magnetic field that extends radially outwardly from the sensor 100′.

Therefore, in summary, despite the circumferential or tangential orientation of individual segments 101a-101l, the collective action of simultaneously energizing opposing segments results in the generation of a magnetic field that radiates radially outwardly to effectively define the sensitivity axis of the sensor 100′. By simultaneously energizing different ones of the segments 101a-101l, the outwardly extending magnetic field can be steered toward a desired azimuthal sector.

The radially outwardly projected electromagnetic field subsequently interacts with the casing strings 25, 24, 23, and 21, inducing eddy currents therein. These eddy currents in turn generate electromagnetic fields, which in turn alter the overall magnetic field distribution in a way that it provides information about the condition of the casing strings 25, 24, 23, and 21.

As these eddy currents decay over time, they do so at a rate that is dependent on the electrical conductivity and permeability of the material of the casing strings 25, 24, 23, and 21. Anomalies, defects, or changes in thickness or composition of the casing material would affect the conductivity and permeability thereof and, therefore, the rate of decay of the eddy currents. Consequently, the rate of change of the magnetic field over time, which results from the decay of the eddy currents, is indicative of the condition of the casing strings 25, 24, 23, and 21.

This resulting change in the magnetic field is sensed by the receiver coils in the segments 101a-101l and logged by the data acquisition system 36. By utilizing the receiver coils to continuously monitor the change in the magnetic field over time and mapping the rate of its change, the sensor 100 enables the determination of the condition of the casing strings 25, 24, 23, and 21.

To obtain a complete azimuthal measurement, the excitation source 33 selectively and sequentially activates the segments 101a-101l in a sequence that over time directs the radially outwardly extending magnetic field to span the entire circumference of casing strings 25, 24, 23, and 21. More particularly, an even number of segments are energized in pairs of opposing groups of any suitable number of segments (e.g., opposing groups of one segment each, opposing groups of two segments each, opposing groups of three segments each, etc). For instance, if segments 101e-101h are activated on one side, the opposite segments 101i-101l will be activated simultaneously, as shown in the operating example of FIG. 3A-3B.

For each pair of segment groups activated, detection of the electromagnetic field generated by the eddy currents induced thereby is performed. This detection may be performed in a variety of ways. For example, detection may be performed using the receiver coils of every segment 101a-101l (not just the segments used for transmission), with the results obtained by each receiver coil being combined as desired in post-detection processing.

As an alternative, the receiver coils of the activated segments may be utilized for detection, with the receiver coils of each group of activated segments being connected in series for detection. For example, if segments 101e-101h and 101i-101l are activated, the receiver coils of segments 101e-101h may be connected in series and utilized for detection as may be the receiver coils of segments 101a-101l.

In fact, the receiver coils of any suitable combination of the segments 101a-101l may be utilized, with combinations of those receiver coils being connected in series for detection, or with detection being performed at each receiver coil on its own.

This transmission and detection sequence is repeated with each subsequent group of opposing segments, systematically activating all segments 101a-101l in a circular manner, generating a radiating electromagnetic field that sweeps radially over the full azimuthal range of the sensor 100.

As the electromagnetic field created by the eddy currents induced in the casing strings 25, 24, 23, and 21 is detected by the receiver coils and mapped over time by the data acquisition system 36, a complete azimuthal profile of the casing's condition may be produced from this data. This process is replicated at various depths, providing for a detailed inspection of the casing strings 25, 24, 23, and 21 throughout their entire length. Consequently, this azimuthally sweeping activation strategy for the sensor 100′ can be utilized to provide a detailed and comprehensive picture of the casing condition.

The selective activating of the segments 101a-101l allows for a high degree of control over the direction and intensity of the radially outwardly extending electromagnetic field. By energizing a different number of segments 101a-101l, or different combinations of segments 101a-101l, the sensor 100′ can modulate the electromagnetic field generated about the casing strings 25, 24, 23, and 21. Thus, the electromagnetic field can be adjusted to meet to specific aims, such as the increase or decrease of penetration depth, to focus on a particular casing string 25, 24, 23, and 21 of interest, or to mitigate the influence of interference.

This flexibility extends to the receiving segments 101a-101l as well. Indeed, the sensor 100′ may receive signals using any suitable number and combination of segments 101a-101l, enabling a wide range of data collection configurations with different characteristics. Indeed, through suitable selection of the receiving segments 101a-101l, higher signal levels may be detected, higher contrast in the results may be obtained, higher sensitivity of the results may be obtained, etc.

The selective activation and reception not only increases the versatility of the sensor 100′ but also increases the accuracy and depth of data collected. The ability to modulate the generated electromagnetic field and the collection pattern provides the sensor 100′ with the ability to adapt to a wide range of casing conditions, casing types, and casing inspection objectives. This provides more effective and reliable casing inspections, effectuating the detection and characterization of potentially critical casing issues, such as corrosion, wear, or material defects.

As explained, the segments 101a-101l are energized by the excitation source 33, under the direction of the controller 34. As previously mentioned, the data acquisition system 36 is responsible for capturing, digitizing, and storing the data individually acquired from the segments 101a-101l of sensor 100′. This data can either be processed by the controller 34 within the wellbore or can be transmitted via the communication system 37 to the surface equipment 44. The communication system 37 connects with the communication device 45, enabling the transmission of the collected data, and the reception of potential operational commands for the tool 30.

On the surface, the data processing system 46 may generate azimuthal corrosion measurement results for the casing strings 25, 24, 23, and 21, based on the transmitted data. This process involves analyzing the data from each segment 101a-101i both individually and in relation to each other. The data processing system 46 may make determinations regarding the condition of the casing strings 25, 24, 23, and 21 by, as explained, evaluating the rate of change of the magnetic field over time, which is reflective of the decay rate of the induced eddy currents within the casing strings. This evaluation yields information about potential anomalies, defects, alterations in thickness, or changes in the composition of the casing material, such as metal loss.

Note that the analysis described, which is performed by the data processing system 46, could also be executed downhole by the controller 34. Therefore, regardless of whether the data is processed downhole or at the surface, a comprehensive understanding of the condition of the casing strings 25, 24, 23, and 21 may be obtained.

As will be appreciated by those of skill in the art, suitable simultaneous activation of multiple segments produces stronger electromagnetic fields and, in turn, a stronger resultant signal. This is because the magnetic fields created by the individually energized segments superpose, creating an overall stronger field. As a result of this, the design of the sensor 100′ has a higher signal-to-noise ratio than conventional sensors, which results from the simultaneous activation of multiple segments. In the presence of multiple concentric casing strings, the signal for detection may become weaker, and the noise level may become comparable to the signal, making the obtainment of meaningful data difficult; however, through the simultaneous energizing of multiple segments, the strength of the combined signal remains sufficiently high in the presence of multiple concentric casing strings, providing for a sufficiently high signal-to-noise ratio to enable the determination of useful information about the condition of said multiple concentric casing strings.

Together with the increased signal-to-noise ratio, the sensor 100′ design increases resolution. Indeed, each segment 101a-101l contributes a distinct subset of azimuthal data, increasing the granularity of the measurements, thereby improving resolution.

The design of the sensor 100′ also provides for the advantage of scalability. Additional segments can be added to increase resolution, with each additional segment contributing a subset of the azimuthal data. As the number of segments increases, the span of the azimuthal sector that each segment is responsible for decreases, leading to a more detailed picture of the condition of the casing across its entire circumference (e.g., increasing the resolution of the azimuthal data provided).

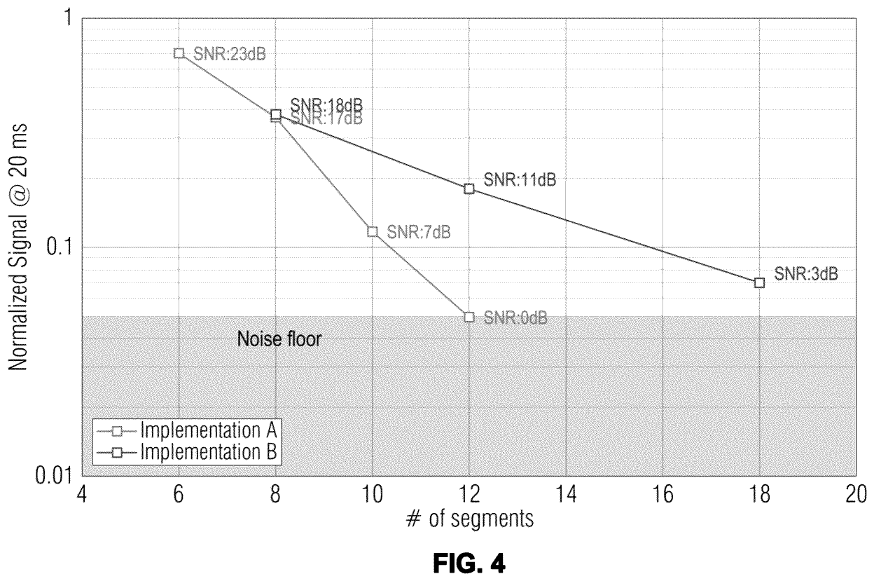

FIG. 4 includes a chart that shows the performance of the sensor 100 of FIGS. 2A-2C as well as the performance of the sensor 100′ of FIGS. 3A-3B. Illustrated is the signal-to-noise ratio (SNR) plotted against the number of segments employed by the sensors. Data obtained from the respective sensors, as well as simulated sensors, are included in the chart to lend further credence to these results. As seen in FIG. 4, the sensor 100 demonstrates a gradual decline in SNR between an increase from 6 to 8 segments, making it particularly useful in certain applications. As also seen in FIG. 4, as the number of segments increases, the sensor 100′ demonstrates a gradual decline in SNR, indicating that the sensor 100′ can maintain a high quality of signal as more segments are added to increase resolution. This robust performance of the sensor 100′ validates the previously mentioned points about the flexibility and adaptability thereof, particularly in applications where more than 8 segments are desired. Indeed, the ability of the sensor 100′ to retain a relatively high SNR even with an increased number of segments demonstrates its casing inspection capabilities.

It is evident that modifications and variations can be made to what has been described and illustrated herein without departing from the scope of this disclosure. For example, one modification would involve mounting the segments 101a-101l onto centralizer arms, which are components used to center the tool 30 within the production casing 25. Indeed, mounting the sensor segments 101a-101l on the centralizer arms, which can pivot and move around the circumference of the production casing 25, could provide for a wide range of movement, helping to effectively facilitate a complete azimuthal casing measurement.

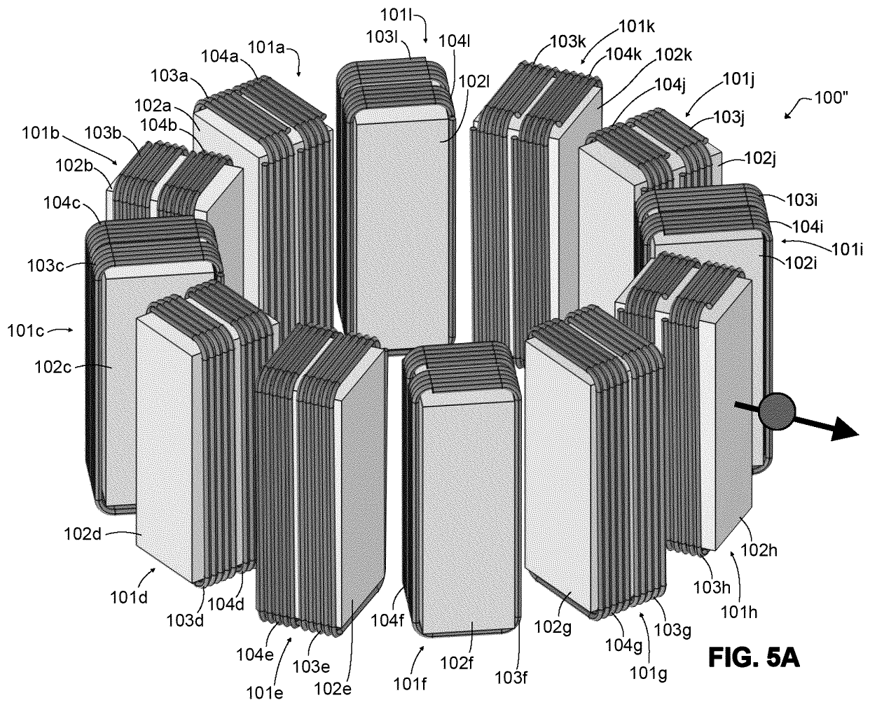

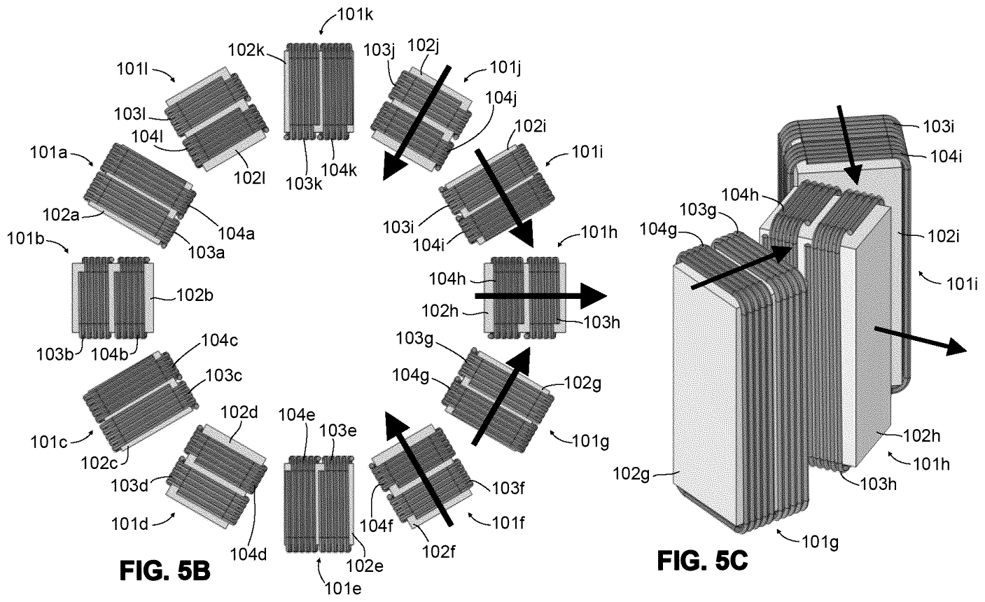

As another example, another embodiment of the sensor 100″ is now described with reference to the perspective view in FIG. 5A, the top view of FIG. 5B, and the enlarged perspective view of FIG. 5C. In this design, the segments 101a-101l have their coil windings 103a-103l and 104a-104l alternatively arranged in the radial direction and the circumferential direction so that segments 101a, 101c, 101e, 101g, 101i, 101k have their sensitivity axes aligned radially outwardly while segments 101b, 101d, 101f, 101h, 101j, 101l have their sensitivity axes aligned along the circumferential/tangential direction. In this example, the coil windings 103a-103l may operate as transmitters while the coil windings 104a-104l may operate as receivers; conversely, the coil windings 104a-103l may operate as transmitters while the coil windings 103a-103l may operate as receivers. As an alternative to the depictions in FIGS. 5A-5C, the segments 101a-101l may have one coil, instead of two coils, with the single coil for each segment 101a-101l acting as a transceiver coil.

As an example of operation of the sensor 100″, when the five adjacent segments 101f-101j are energized with the illustrated magnetic moments (e.g., the electromagnetic field pointing radially inwardly from segments 101f and 101j, the electromagnetic field pointing radially outwardly from segment 101h, the electromagnetic field pointing circumferentially clockwise from segment 101i, and the electromagnetic field pointing circumferentially counter clockwise from segment 101g), they form a Halbach array that enhance the electromagnetic field that enhances the electromagnetic field on the outer side (e.g., in the direction radially outwardly from segment 101h) and reduces the electromagnetic field on the inner side (e.g., radially inwardly from segment 101h). Thus, the resulting electromagnetic field projects radially outwardly in an azimuthal direction determined by which of the segments 101a-101l are energized to interact with the casing strings 25, 24, 23, and 21, as described above, facilitating the determination of the condition of the casing strings 25, 24, 23, and 21 as described above.

For better clarity, the design of sensor 100″ organizes its segments 101a-101l into distinct, activatable azimuthal units. When energized in specific sequences, these segments effectively form a Halbach array.

The Halbach array is able to steer the outgoing electromagnetic field in a desired direction and may also potentially be able to vary the field focus depth by optimizing the number of segments and the arrangement of the magnetic axes. In the illustrated case in FIG. 5B, the focused electromagnetic field is directed radially outward from segment 101h, due to the arrangement of the segments in the Halbach array configuration. This provides for the transmitted field being intense, enhancing the ability of the sensor 100″ to interrogate the casing strings 25, 24, 23, and 21.

In the depicted example, the activated sequence comprises segments 101g, 101h, and 101i. Segments 101i and 101g, positioned at the ends of the sequence, are configured for circumferential sensitivity and sense part-circumferential arcs around the casing, providing a lateral perspective on the casing's condition. The central segment 101h focuses its sensing radially outward. Positioned prior to this sequence, segment 101f senses radially inward, offering another view from that azimuthal position. Similarly, segment 101j, following the mentioned sequence, gives another perspective but from its specific azimuthal location.

The benefits of the Halbach array are evident during sensing. Segments 101f-101j capture a detailed image of a particular azimuthal section of the casing strings 25, 24, 23, and 21, allowing sensor 100″ to obtain direct outward data (primarily from segment 101h) and wider contextual insights from the surrounding segments. This configuration, influenced by the Halbach array, results in a well-defined local near-field magnetic return, providing for good azimuthal sensitivity. Note that this arrangement can be modified, adjusting the ratio between segments with radial sensitivity and those with circumferential sensitivity, allowing adjustment for specific measurement desires or casing conditions.

As with the above described sensor 100′, to obtain a complete azimuthal measurement using the sensor 100″, the excitation source 33 selectively and sequentially activates the segments 101a-101l according to the azimuthal units, in a sequence that over time directs the radially outwardly extending magnetic field to span the entire circumference of casing strings 25, 24, 23, and 21.

For each azimuthal unit activated, detection of the electromagnetic field generated by the eddy currents induced in the casing strings 25, 24, 23, and 21 thereby is performed. Receiving electromagnetic data via individual segments 101a-101l, especially those aligned radially like segment 101h, further amplifies this azimuthal sensitivity. By individually activating and reading from specific segments 101a-101l, the sensor 100″ can capture more nuanced, granular data from distinct azimuthal sections. Such alternate segment arraying is combines the strengths of multi-segment firing with the precision of individual segment reception. Depending on the desires or the specifics of the environment being surveyed, the firing pattern can be adapted, even beyond the Halbach configuration, to accommodate other array types.

Detection may be performed using the receiver coils of every segment 101a-101l, with the results obtained by each receiver coil being combined as desired in post-detection processing. For example, reception may be performed at the receiver coils of each segment 101a-101l, and then processing may be performed to add or subtract one or more of the received signals from one or more of the received signals. As another alternative, reception may be performed using certain combinations of the receiver coils of the segments 101a-101l, with the results then being added or subtracted as desired. Still further, reception may be performed using certain combinations of the receiver coils of the segments 101a-101l connected such that the results are added or subtracted.

As an alternative, the receiver coils of the activated segments may be utilized for detection, with the receiver coils of each group of activated segments being connected in series for detection. Indeed, the receiver coils of any suitable combination of the segments 101a-101l may be utilized, with combinations of those receiver coils being connected in series for detection, or with detection being performed at each receiver coil on its own, providing for differently selectable distinct sensitivity profiles.

The above described sensor embodiments 100, 100′, or 100″ may be integrated into a larger sensor assembly which includes solenoids positioned both above and below the sensors 100, 100′, 100″ that serve to amplify the electromagnetic signal intensity and amplify directional sensitivity.

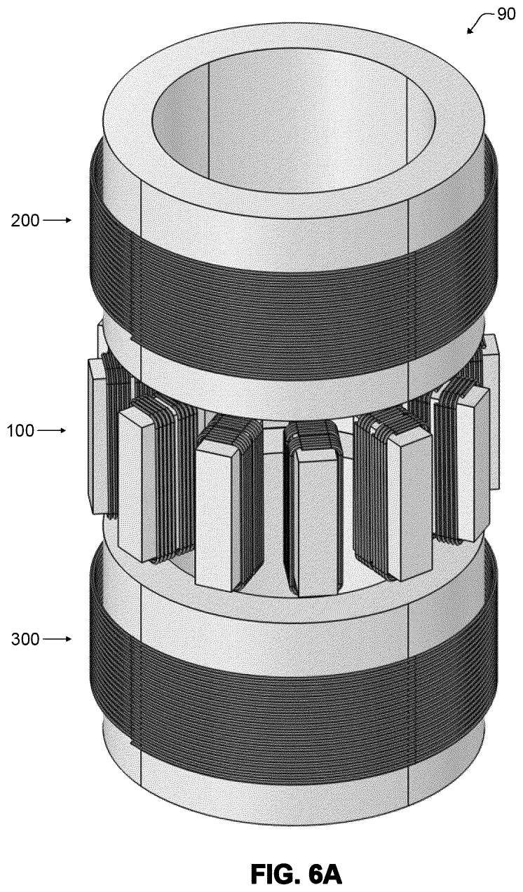

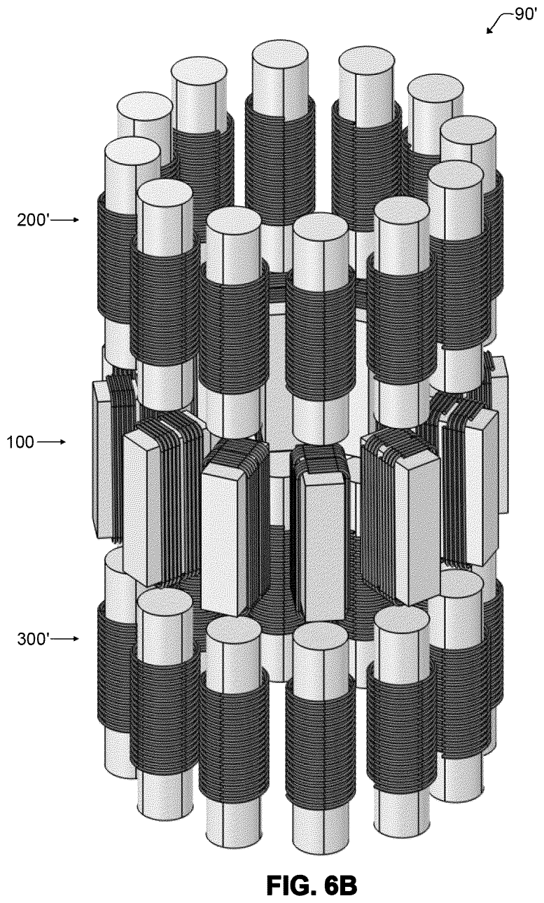

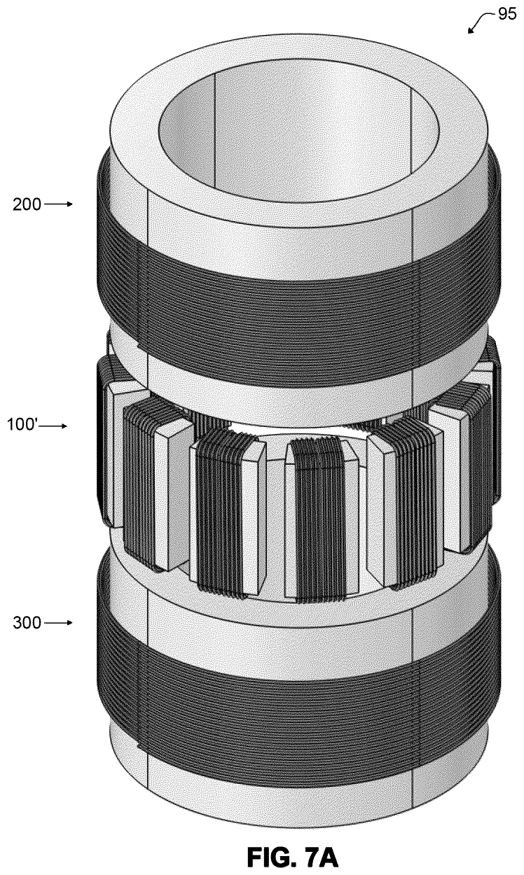

Depicted in FIG. 6A is one such sensor assembly 90, where single-core solenoids 200 and 300 are positioned above and below the sensor 100. A variation of this sensor 90′ is shown in FIG. 6B, in which the solenoids 200′ and 300′ are segmented to provide for granular control over the electromagnetic field distribution as altered by the solenoids, allowing adjustment for specific applications, for example according to the transmission sequence of the segments.

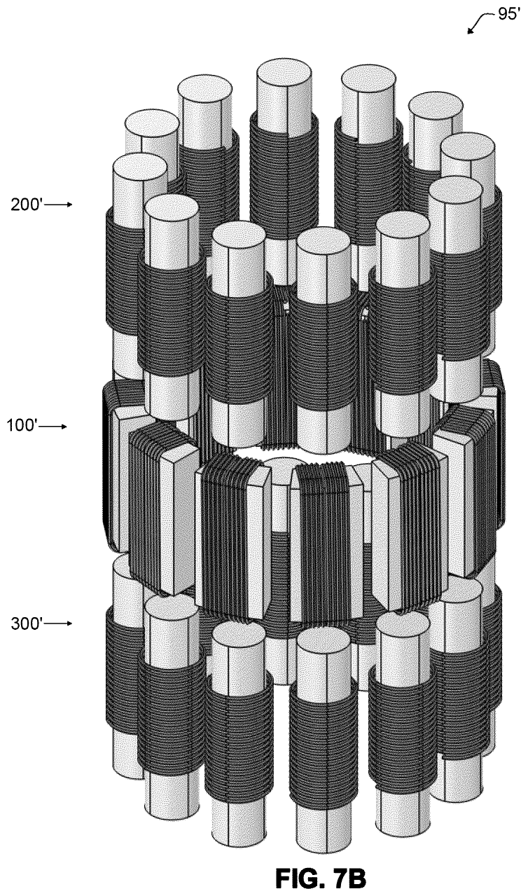

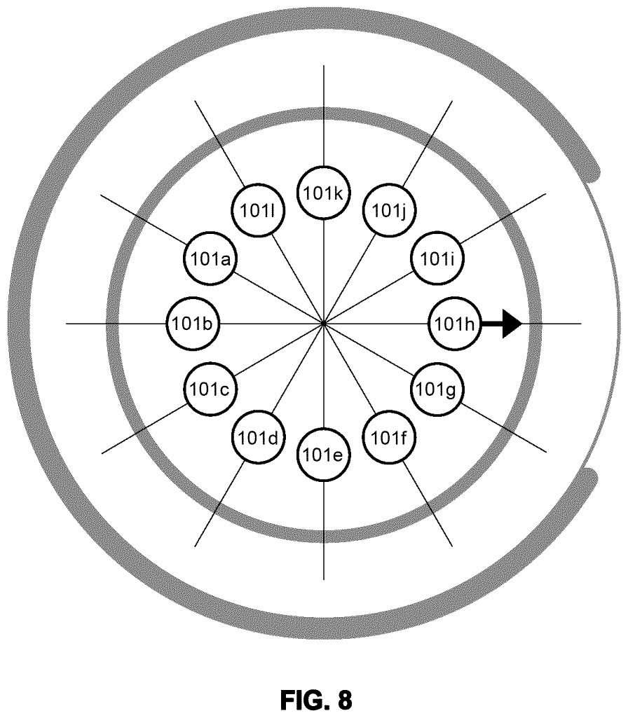

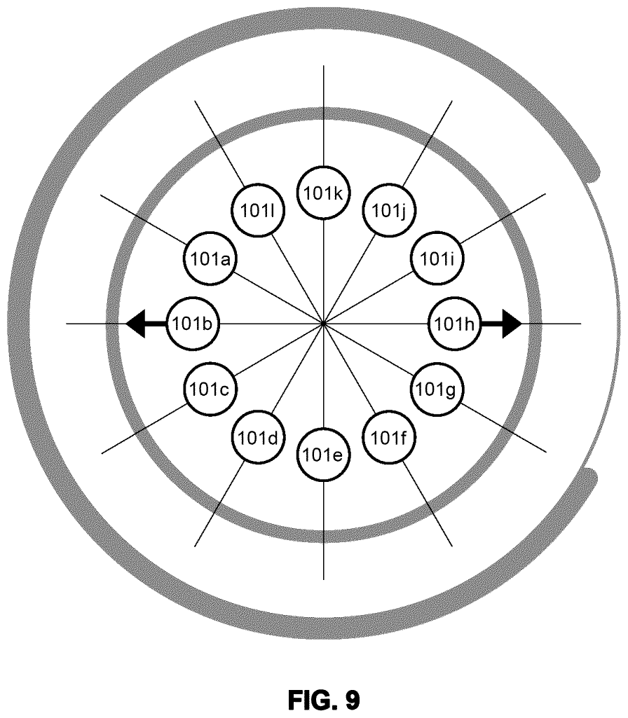

Similarly depicted in FIG. 7A is a sensor assembly 95, where single-core solenoids 200 and 300 are positioned above and below the sensor 100′. A variation of this sensor assembly 95′ is shown in FIG. 7B, in which the solenoids 200′ and 300′ are segmented to provide for granular control over the electromagnetic field distribution as altered by the solenoids, allowing adjustment for specific applications, for example according to the transmission sequence of the segments.

Although not shown, it should be appreciated that the sensor 100″ may also be used with either of the solenoid configurations.

In each of the above examples, the sensors 100, 100′, 100″ or sensor assemblies 90, 90′, 95, 95′ direct their radially outwardly extending electromagnetic field toward a single azimuthal sector at a time, and sweep across each azimuthal sector to obtain azimuthal data about the complete circumference of the casing strings 25, 24, 23, and 21 at a given depth. A diagram illustrating this is shown in FIG. 8, in which segment 101h is energized to probe its associated azimuthal sector, while segments 101a-101g, 101i-101l are not energized.

This need not be the case, however. Instead of a focus on a singular azimuthal sector at a time, multiple segments from among 101a-101l can be energized to produce radially outwardly extending electromagnetic fields targeting multiple, symmetric azimuthal sectors. This is shown in FIG. 9 where, within the configuration of sensor 100, segments 101h and 101b are simultaneously activated, creating fields directed at diametrically opposed azimuthal sectors of the casing strings 25, 24, 23, and 21. This enhances the azimuthal resolution of the sensors in use. Essentially, by energizing any symmetric set of two or more segments, such as 101c, 101g, and 101k, symmetrical configurations of radially outward fields can be generated that align with corresponding symmetric azimuthal sectors.

When a segment such as 101h is energized as shown in FIG. 8, it induces eddy currents in the casing strings 25, 24, 23, and 21 directly in front of it. These induced eddy currents circulate within the casing strings in loop patterns. Over time, these eddy current loops expand in size while the intensity of the currents diminish. Eventually, the eddy current loops encompass the entire circumference of the casing strings 25, 24, 23, and 21. At this time then, the presence of corrosion or anomalies in a casing string (e.g., casing string 24), causes a change in the pattern and evolution of the eddy currents. This results in a detectable change in the signal received by the segment or segments acting as receivers, and analysis of this signal permits identification and quantification of corrosion and other irregularities.

When opposing segments such as 101h and 101b of the sensor 100 are simultaneously energized as shown in FIG. 9, two concurrent eddy current loops are produced within the casing strings 25, 24, 23, and 21 on azimuthally opposing sides thereof. The presence of each eddy current loop restricts the expansion of the other eddy current loop, preventing it from spanning the full circumference of the casing strings. In this configuration, presence of corrosion or anomalies in a casing string (e.g., casing string 24) incites a more pronounced alteration in the eddy current pattern and its development over time. This results in a more significant change in the signal captured by the segment or segments acting as receivers, enhancing azimuthal sensitivity, allowing easier detection of localized anomalies across multiple casing strings.

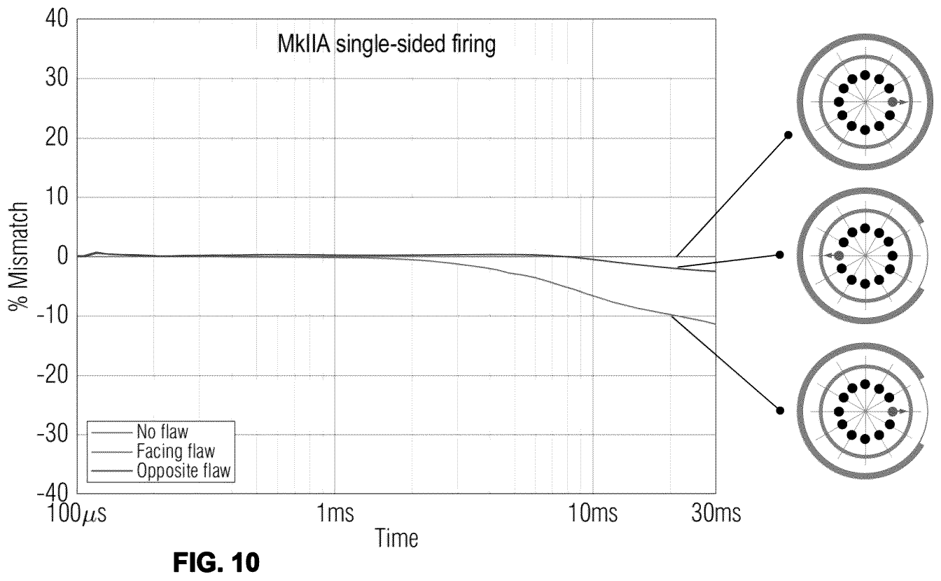

Numerical simulations have been executed to validate the above discussed technique and its efficacy in detecting anomalies within casing strings. In FIG. 10, a graphical representation depicts the distinction in terms of percentage contrast between instances with and without flaws when employing the technique of FIG. 8, shown for different ones of the segments firing. When examining a flaw that spans an angular measure of 60 degrees, has a width of 4 inches, and represents a complete 100% metal loss, the sensitivity is approximately 10% at later stages of measurement. This essentially means that the method of FIG. 8 offers a 10% sensitivity when detecting a significant flaw.

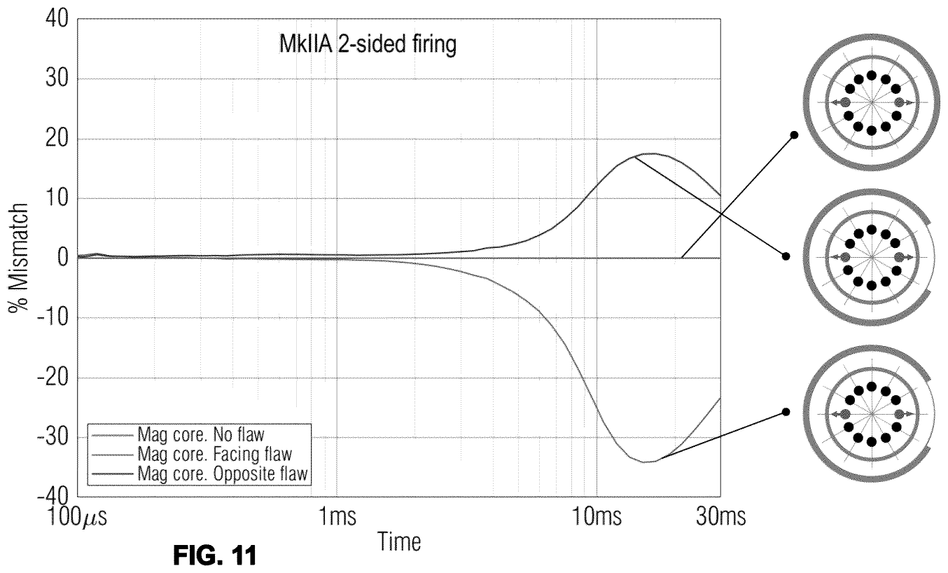

On the other hand, FIG. 11 illustrates the percentage contrast between the flaw and no-flaw scenarios when the azimuthal sensor segments are driven using the technique of FIG. 9. For an identical flaw size of 60 degrees×4 inches and accounting for a 100% metal loss, the sensitivity is more dynamic, oscillating between −33% at segment 101h and +17% at segment 101b, as visualized by the illustrated curves. This offers a peak-to-peak sensitivity of 50%, which is substantially higher than that achievable using the method of FIG. 8. providing for more accurate casing corrosion detection, including the detection of flaws in the casing string 24 not previously detectable. This may be of particular use when a well is a candidate for plugging and abandonment—in such instances, the integrity of the casing string 24 is of particular interest as an area of leakage would need to be plugged prior to plugging of the well itself for abandonment.

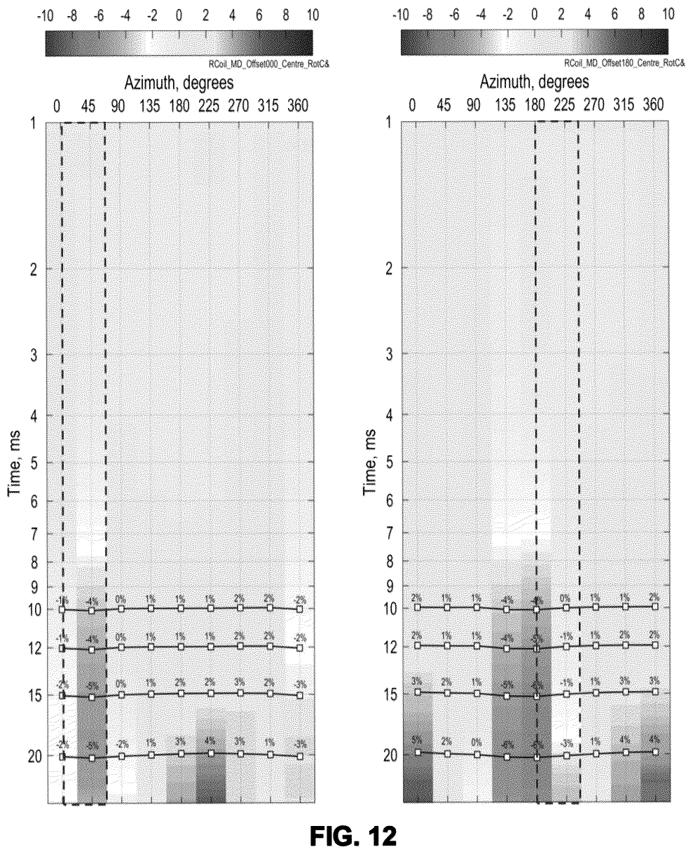

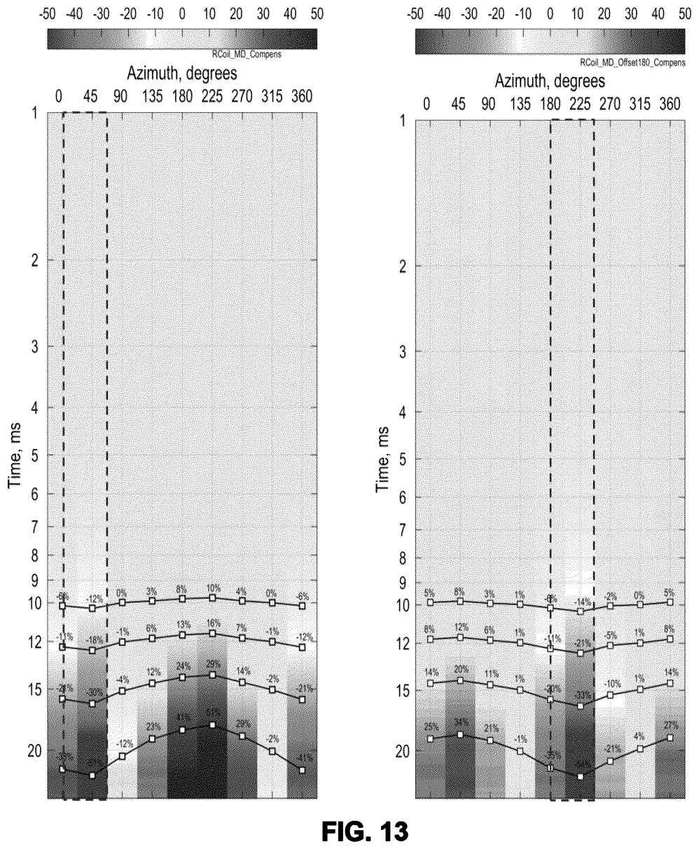

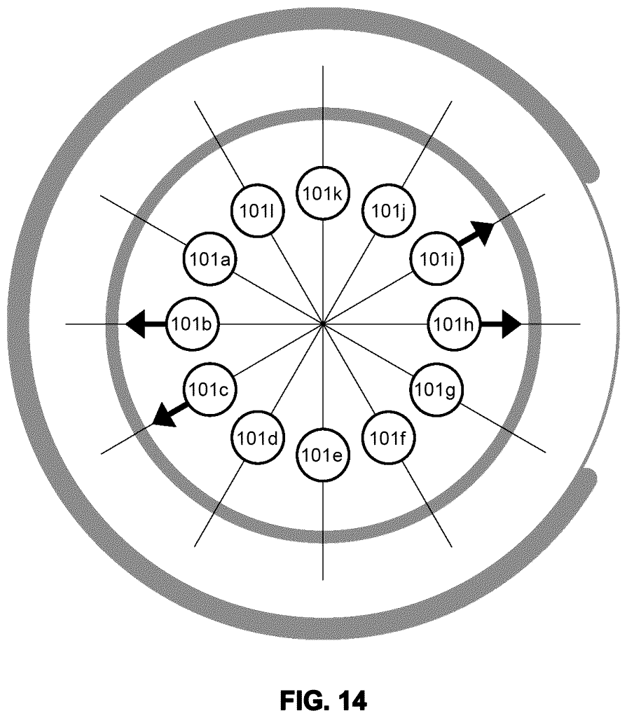

Laboratory experiments further validate these findings. Shown in FIG. 12 are visual depth logs for a scenario wherein there is a flaw of 60 degrees×5 inches, accompanied by a complete 100% metal loss, specifically on the casing string 24 at 30° azimuth (left side) and 210° azimuth (right side). When the azimuthal sensor is driven using the method of FIG. 8, the measured sensitivity, represented by the peak-to-peak values, is estimated to be around 10%. This confirms the above references numerical simulations. In contrast, FIG. 13 visual depth logs under the same conditions but with the sensor being driven using the technique of FIG. 9. Here, the measured peak-to-peak sensitivity rises to 90%, representing a considerable increase in sensitivity.

In the example of FIG. 9, multiple opposing ones of the segments 101a-101l are energized to cause generation of radially outwardly expending electromagnetic fields extending toward two radially opposite azimuthal sectors of the casing strings 25, 24, 23, and 21. However, this technique is not limited to two-sector probing. Indeed, more than two radially outwardly expanding electromagnetic fields may be generated and directed toward multiple, either oppositely positioned or equidistantly azimuthally spaced, sectors of the casing strings 25, 24, 23, and 21.

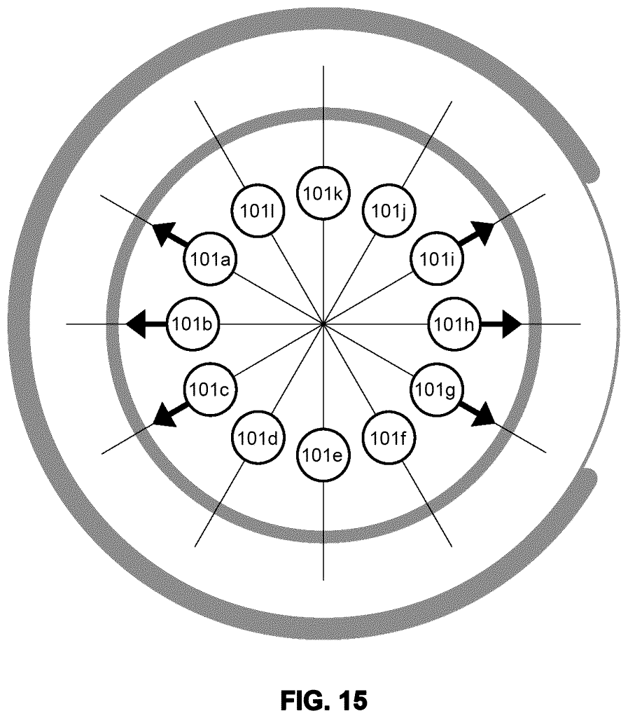

To illustrate this concept further, consider the configuration presented in FIG. 14. Here, segments 101b and 101c on one side, and segments 101i and 101h on the opposite side, are simultaneously energized. This design results in probing of four different azimuthal sectors at once. Additionally, another variant shown in the same FIG. 15 features the energization of three consecutive segments on each side: segments 101a through 101c and segments 101g through 101i. By activating these segments in tandem, a substantial amount of the circumference of the casing strings being investigated is probed.

The above described techniques of energizing multiple opposing segments to yield radially outwardly expanding electromagnetic fields extending toward radially opposed azimuthal sectors are well-suited for adaptation with the various sensors 100, 100′, 100″ and sensor assemblies 90, 90′, 95, 95′ described herein, each offering unique advantages due to their respective configurations. Indeed, these techniques may be used with any sensor design capable of generating a radially outgoing electromagnetic field suitable for probing casing in an azimuthal sector, and need not utilize the various sensors 100, 100′, 100″ and sensor assemblies 90, 90′, 95, 95′ described herein.

Additional optional details pertaining to FIGS. 3A-3C. 6A-6B, 7A-7B are now given, with it being understood that the scope of the claims of this patent application are not limited to the details provided hereinbelow and that the scope of this patent application is not limited to or by any specific feature or detail provided hereinbelow. Generally speaking, these drawing figures teach a wellbore casing corrosion measurement tool, comprising: a sensor apparatus and control circuitry. The sensor apparatus comprises: a plurality of sensor segments arranged into a segmented cylindrical shape such that a sensitivity axis of each sensor segment is aligned along a circumferential direction. The control circuitry is configured to: energize transmitter coils at first and second sets of the sensor segments positioned radially opposite from one another about a circumference of the sensor apparatus in an antiparallel manner so that magnetic fields generated the first and second sets of sensor segments have propagation directions toward one another, thereby forming a net magnetic field that extends radially outwardly from the sensor to induce eddy currents in at least one wellbore casing string; and detect a rate of change in a magnetic field generated by the eddy currents in the at least one wellbore casing string over time via receiver coils at selected ones of the sensor segments, the detected rate of change being indicative of condition of the at least one wellbore casing string.

The control circuitry selectively activates different sets of sensor segments in an antiparallel manner so that magnetic fields generated thereby have propagation directions toward one another, such that the net magnetic field that extends radially outwardly from the sensor induce eddy currents in different azimuthal sectors of the at least one wellbore casing string. In addition, the control circuitry detects the rates of change in the magnetic fields generated by the eddy currents induced in the different azimuthal sectors of the at least one wellbore casing string, the rates of change being indicative of the conditions of the at least one wellbore casing string at the different azimuthal sectors thereof.

Each of the plurality of sensor segments is comprised of: at least one transmitter coil; and at least one receiver coil.

Each of the plurality of sensor segments is comprised of at least one transceiver coil. The control circuitry comprises: a controller; an excitation source; and a data acquisition system. The controller is operatively connected to the excitation source for controlling the energizing of the transmitter coils and is also operatively connected to the data acquisition system for recording measurements from the receiver coils.

The control circuitry detects the rate of change in the magnetic field generated by the eddy currents over time via the receiver coils at each of the sensor segments.

The control circuitry is further configured to combine the rate of change in the magnetic field detected via each of the receiver coils in a desired fashion to determine a condition of the at least one wellbore casing string.

The control circuitry is configured to subtract the rate of change in the magnetic field detected by receiver coils of the second set of sensor segments from the rate of change in the magnetic field detected by receiver coils of the first set of sensor segments, and to determine a condition of the at least one wellbore casing string based upon a result of the subtraction.

The control circuitry is configured to add the rate of change in the magnetic field detected by receiver coils of the second set of sensor segments to the rate of change in the magnetic field detected by receiver coils of the first set of sensor segments, and to determine a condition of the at least one wellbore casing string based upon a result of the addition.

The sensor apparatus further comprises at least one solenoid positioned adjacent the plurality of sensor segments along a longitudinal axis of the wellbore casing corrosion measurement tool.

The at least one solenoid may be comprised of a single coil, or may be comprised of multiple coils.

Also pertaining to the above reference drawing figures is a method for measuring corrosion of at least one wellbore casing string. The method comprises: deploying a tool including a sensor apparatus into the at least one wellbore casing string; energizing transmitter coils of first and second sets of sensor segments positioned radially opposite from one another about a circumference of the sensor apparatus in an antiparallel manner, thereby generating magnetic fields whose propagation directions are circumferentially toward one another to thereby form a net magnetic field that extends radially outwardly from the sensor apparatus; inducing eddy currents in the at least one wellbore casing string via the radially outwardly extending magnetic field; detecting a rate of change in a magnetic field generated by the eddy currents in the at least one wellbore casing string over time via receiver coils at selected ones of sensor segments of the sensor apparatus; recording the detected rate of change; and analyzing the recorded rate of change to identify potential areas of corrosion in the at least one wellbore casing string, the identification based on the detected rate of change which is indicative of a condition of the at least one wellbore casing string.

The energizing of the transmitter coils of the first and second sets is performed in a sequential manner that sequentially changes which coils of what sensor segments are members of the first and second sets, thereby causing the radially outwardly extending magnetic field to sweep radially over a full azimuthal range of the sensor to sequentially induce eddy currents in each different azimuthal sector of the at least one wellbore casing string. The rate of change is detected in the magnetic fields generated by the eddy currents in each different azimuthal sector of the at least one wellbore casing string. The detected rates of change in each different azimuthal sector are recorded. The recorded rates of change in each different azimuthal sector of the at least one wellbore casing are analyzed to identify potential areas of corrosion over a full azimuthal range of the at least one wellbore casing string.

The rate of change in the magnetic field generated by the eddy currents over time is detected via the receiver coils at each of the sensor segments, with the rate of change detected at each receiver coil being recorded and analyzed.

The analysis includes combining the rate of change detected at each receiver coil in a desired fashion.

The method further includes subtracting the rate of change in the magnetic field detected by receiver coils of the second set of sensor segments from the rate of change in the magnetic field detected by receiver coils of the first set of sensor segments, and determining a condition of the at least one wellbore casing string based upon a result of the subtraction.

The method further includes adding the rate of change in the magnetic field detected by receiver coils of the second set of sensor segments to the rate of change in the magnetic field detected by receiver coils of the first set of sensor segments, and determining a condition of the at least one wellbore casing string based upon a result of the addition.

Additional details pertaining to FIGS. 5A-5C, 6A-6B, 7A-7B are now given, with it being understood that the scope of the claims of this patent application are not limited to the details provided hereinbelow and that the scope of this patent application is not limited to or by any specific feature or detail provided hereinbelow.

Generally speaking, these drawing figures teach a wellbore casing corrosion measurement tool, comprising: a sensor apparatus and control circuitry. The sensor apparatus comprises: a plurality of sensor segments organized in a segmented cylindrical shape, wherein segments alternate between having their sensitivity axes aligned radially outwardly and along a circumferential direction, forming a Halbach array configuration. The control circuitry is configured to: energize transmitter coils at a selected sequence of the sensor segments such that the energized sequence create a magnetic field extending radially outwardly from a central sensor segment of the sequence, due to the Halbach array configuration, to induce eddy currents in at least one wellbore casing string; and detect a rate of change in a magnetic field generated by the eddy currents in the at least one wellbore casing string over time via receiver coils at specific ones of the sensor segments, the detected rate of change being indicative of a condition of the at least one wellbore casing string.

The control circuitry selectively activates specific sequences of sensor segments in accordance with the Halbach array configuration, such that the magnetic fields generated by each sequence are focused in different azimuthal directions to induce eddy currents in different azimuthal sectors of the at least one wellbore casing string. The control circuitry detects the rates of change in the magnetic fields generated by the eddy currents induced in the different azimuthal sectors of the at least one wellbore casing string, the rates of change being indicative of the conditions of the at least one wellbore casing string at the different azimuthal sectors thereof.

Each of the plurality of sensor segments is comprised of: at least one transmitter coil; and at least one receiver coil.

The control circuitry comprises: a controller; an excitation source; and a data acquisition system.

The controller is operatively connected to the excitation source for controlling the energizing of the transmitter coils and is also operatively connected to the data acquisition system for recording measurements from the receiver coils.

The control circuitry detects the rate of change in the magnetic field generated by the eddy currents over time via the receiver coils at each of the sensor segments.

The control circuitry is further configured to combine the rate of change in the magnetic field detected via each of the receiver coils in a desired fashion to determine a condition of the at least one wellbore casing string.

Also pertaining to the above reference drawing figures is a method for measuring corrosion of at least one wellbore casing string. The method comprises: deploying a tool including a sensor apparatus into the at least one wellbore casing string; energizing transmitter coils of sensor segments in a Halbach configuration to focus their magnetic fields radially outward from the sensor apparatus and circumferentially towards neighboring segments; inducing eddy currents in the at least one wellbore casing string via the radially outwardly extending magnetic field; detecting a rate of change in a magnetic field generated by the eddy currents in the at least one wellbore casing string over time via receiver coils at the sensor segments of the sensor apparatus; recording the detected rate of change; and analyzing the recorded rate of change to identify potential areas of corrosion in the at least one wellbore casing string, the identification based on the detected rate of change which is indicative of a condition of the at least one wellbore casing string.

The energizing of the transmitter coils of the sensor segments using the Halbach configuration is performed in a sequential manner that sequentially changes which coils of what sensor segments are energized to thereby select a different sequence of sensor segments, resultingly causing the radially outwardly extending magnetic field to sweep radially over a full azimuthal range of the sensor to sequentially induce eddy currents in each different azimuthal sector of the at least one wellbore casing string. The rate of change is detected in the magnetic fields generated by the eddy currents in each different azimuthal sector of the at least one wellbore casing string. The detected rates of change in each different azimuthal sector are recorded. The recorded rates of change in each different azimuthal sector of the at least one wellbore casing are analyzed to identify potential areas of corrosion over a full azimuthal range of the at least one wellbore casing string.

The rate of change in the magnetic field generated by the eddy currents over time is detected via the receiver coils at each of the sensor segments, with the rate of change detected at each receiver coil being recorded and analyzed.

The analysis includes combining the rate of change detected at each receiver coil in a desired fashion.

Additional details pertaining to FIGS. 2A-2C, 6A-6B, 7A-7B are now given, with it being understood that the scope of the claims of this patent application are not limited to the details provided hereinbelow and that the scope of this patent application is not limited to or by any specific feature or detail provided hereinbelow. Generally speaking, these drawing figures teach a wellbore casing corrosion measurement tool, comprising: a sensor apparatus and control circuitry. The sensor apparatus comprises: a plurality of sensor segments arranged into a segmented cylindrical shape such that a sensitivity axis of each sensor segment is aligned along a radial direction. The control circuitry is configured to: energize a transmitter coil of a sensor segment so that a magnetic field generated at the sensor segment extends radially outwardly from the sensor to induce eddy currents in at least one wellbore casing string; and detect a rate of change in a magnetic field generated by the eddy currents in the at least one wellbore casing string over time via receiver coils at selected ones of the sensor segments, the detected rate of change being indicative of condition of the at least one wellbore casing string.

The control circuitry sequentially activates individual sensor segments such that the magnetic fields generated thereby extend radially outwardly, inducing eddy currents in different azimuthal sectors of the at least one wellbore casing string; and wherein the control circuitry detects the rates of change in the magnetic fields generated by the eddy currents induced in the different azimuthal sectors of the at least one wellbore casing string, the rates of change being indicative of the conditions of the at least one wellbore casing string at the different azimuthal sectors thereof.

Each of the plurality of sensor segments is comprised of: a transmitter coil; and a receiver coil.

The control circuitry comprises: a controller; an excitation source connected to the controller for controlling the energizing of the transmitter coils; and a data acquisition system connected to the controller for recording measurements from the receiver coils.

The control circuitry detects the rate of change in the magnetic field generated by the eddy currents over time via the receiver coil of each of the sensor segments.

The control circuitry is further configured to analyze the rate of change in the magnetic field detected via each of the receiver coils to determine a condition of the at least one wellbore casing string.

The control circuitry is configured to process the rate of change in the magnetic field detected by receiver coils of different sensor segments, and to determine a condition of the at least one wellbore casing string based upon the processing.

The control circuitry is configured to analyze the rates of change in the magnetic fields detected by receiver coils of various sensor segments, and to determine a condition of the at least one wellbore casing string based upon the analysis.

At least one solenoid may be positioned adjacent the plurality of sensor segments along a longitudinal axis of the wellbore casing corrosion measurement tool.

The at least one solenoid may be comprised of a single coil or multiple coils.

Also pertaining to the above reference drawing figures is a method for assessing a condition of at least one wellbore casing string using a wellbore casing corrosion measurement tool. The method comprises: deploying the tool into the at least one wellbore casing string, the tool having a sensor apparatus with a plurality of sensor segments; energizing a transmitter coil of a selected sensor segment so that a magnetic field generated at the sensor segment extends radially outwardly from the sensor to induce eddy currents in the at least one wellbore casing string; detecting a rate of change in a magnetic field generated by the eddy currents in the at least one wellbore casing string over time via receiver coils at selected ones of the sensor segments; recording the detected rate of change; and analyzing the recorded rate of change to determine potential conditions of the at least one wellbore casing string based on the detected rate of change.

The energizing of the transmitter coil is performed in a manner that sequentially energizes transmitter coils of different sensor segments, causing the radially outwardly extending magnetic field to rotate and thereby induce eddy currents in each different azimuthal sector of the at least one wellbore casing string. The method includes detecting the rate of change in the magnetic fields generated by the eddy currents in each different azimuthal sector of the at least one wellbore casing string, and recording the detected rates of change in each different azimuthal sector. The method further includes analyzing the recorded rates of change in each azimuthal sector to determine potential conditions over a full azimuthal range of the at least one wellbore casing string.

The rate of change in the magnetic field generated by the eddy currents over time is detected via the receiver coils at each of the sensor segments, and the rate of change detected at each receiver coil is recorded and analyzed.

The method includes processing the rate of change in the magnetic field detected by receiver coils of various sensor segments, and determining a condition of the at least one wellbore casing string based on the processing.

The analysis involves combining the rates of change detected from various sensor segments to determine potential areas of condition or variation in the at least one wellbore casing string.

Additional details pertaining to FIGS. 8-9, 14-15, 6A-6B, 7A-7B are now given, with it being understood that the scope of the claims of this patent application are not limited to the details provided hereinbelow and that the scope of this patent application is not limited to or by any specific feature or detail provided hereinbelow. Generally speaking, these drawing figures teach a wellbore casing corrosion measurement tool, comprising: a sensor assembly; and control circuitry. The control circuitry is configured to: energize selected components of the sensor assembly to produce multiple radially outwardly extending electromagnetic fields that are symmetrically arranged about a circumference of the sensor assembly to induce eddy currents in at least one wellbore casing string; and detect variations in magnetic fields resulting from the eddy currents in the at least one wellbore casing string via the sensor assembly, said variations being indicative of a state of the at least one wellbore casing string.

The sensor assembly comprises a plurality of sensor segments arranged into a segmented cylindrical shape such that a sensitivity axis of each sensor segment is aligned along a radial direction.

The symmetrically arranged electromagnetic fields are formed by simultaneously energizing multiple diametrically opposing sensor segments.

The symmetrically arranged electromagnetic fields are formed by simultaneously energizing multiple groups of diametrically opposing sensor segments.

The control circuitry is further configured to change the selected components of the sensor assembly being energized over time to shift focus of the symmetrically arranged electromagnetic fields about the circumference of the sensor assembly to thereby investigate different azimuthal sectors of the at least one wellbore casing string via the sensor assembly.

The sensor assembly comprises multiple groups of sensor segments, each group configured to generate a radially outwardly extending electromagnetic field. Each of said groups of sensor segments includes first and second sets of sensor segments positioned radially opposite from one another about the circumference of the sensor assembly in an antiparallel manner. Magnetic fields generated by the first and second sets of sensor segments within each group when energized by the control circuitry have propagation directions oriented toward one another, forming a net magnetic field that extends radially outwardly from that group to form one of the radially outwardly extending electromagnetic fields that induces eddy currents in the at least one wellbore casing string.

The control circuitry is further configured to change which groups of sensor segments are energized over time, thereby shifting focus of the radially outwardly extending electromagnetic fields about a circumference of the sensor assembly to thereby investigate different azimuthal sectors of the at least one wellbore casing string via the sensor assembly.

The sensor assembly comprises multiple groups of sensor segments, each group organized in a segmented cylindrical shape. In each of the groups of sensor segments, the sensor segments alternate between having their sensitivity axes aligned radially outwardly and along a circumferential direction, thereby forming a Halbach array configuration. The control circuitry is configured to energize transmitter coils at a selected sequence of the sensor segments within each group such that, due to the Halbach array configuration, the energized sequence creates a magnetic field extending radially outwardly from a central sensor segment of the sequence to thereby generate one of the radially outwardly extending electromagnetic fields that induces eddy currents in the at least one wellbore casing string.

The control circuitry is further configured to change which groups of sensor segments are energized over time, thereby shifting focus of the radially outwardly extending electromagnetic fields about a circumference of the sensor assembly to thereby investigate different azimuthal sectors of the at least one wellbore casing string via the sensor assembly.

Also pertaining to the above reference drawing figures is a method for assessing a condition of at least one wellbore casing string using a wellbore casing corrosion measurement tool. The method comprises: deploying the tool into the at least one wellbore casing string, the tool having a sensor assembly; energizing selected components of the sensor assembly to produce multiple radially outwardly extending electromagnetic fields that are symmetrically arranged about a circumference of the sensor assembly to thereby induce eddy currents in the at least one wellbore casing string with the produced electromagnetic fields; detecting a rate of change in a magnetic field generated by the eddy currents in the at least one wellbore casing string over time via at selected ones of the components of the sensor assembly; recording the detected rate of change; and analyzing the recorded rate of change to determine potential conditions of the at least one wellbore casing string based on the detected rate of change.

The symmetrically arranged electromagnetic fields are formed by simultaneously energizing multiple diametrically opposing sensor segments of the sensor assembly.

The symmetrically arranged electromagnetic fields are formed by simultaneously energizing multiple groups of diametrically opposing sensor segments of the sensor assembly.

The method includes changing the selected components of the sensor assembly being energized over time to shift focus of the symmetrically arranged electromagnetic fields about circumference of the sensor assembly to thereby investigate different azimuthal sectors of the at least one wellbore casing string.

Energizing the selected components of the sensor assembly comprises generating radially outwardly extending electromagnetic fields from multiple selected groups of sensor segments of the sensor assembly by causing each selected group to generate magnetic fields at first and second sets of sensor segments within that selected group to have propagation directions oriented toward one another, forming a net magnetic field that extends radially outwardly from that selected group to form one of the radially outwardly extending electromagnetic fields that induces eddy currents in the at least one wellbore casing string.

Energizing the selected components of the sensor assembly comprises generating radially outwardly extending electromagnetic fields from multiple selected groups of sensor segments of the sensor assembly by causing each selected group to energize transmitter coils at a chosen sequence of the sensor segments within that selected group arranged in a Hallbach array configuration to produce a magnetic field extending radially outwardly from a central sensor segment of the Hallbach array configuration, thereby creating one of the radially outwardly extending electromagnetic fields that induces eddy currents in the at least one wellbore casing string.

Although this disclosure has been described with a limited number of embodiments, those skilled in the art, having the benefit of this disclosure, can envision other embodiments that do not deviate from the disclosed scope. Furthermore, skilled persons can envision embodiments that represent various combinations of the embodiments disclosed herein made in various ways.

1. A wellbore casing corrosion measurement tool, comprising:
a sensor assembly; and
control circuitry configured to:
energize selected components of the sensor assembly to produce multiple electromagnetic fields that are arranged about a circumference of the sensor assembly to induce eddy currents in at least one wellbore casing string; and
detect magnetic fields resulting from the eddy currents in the at least one wellbore casing string via the sensor assembly, said magnetic fields being indicative of a state of the at least one wellbore casing string.

2. The wellbore casing corrosion measurement tool of claim 1, wherein the selected components of the sensor assembly are energized to produce multiple radially outwardly extending electromagnetic fields that are arranged about a circumference of the sensor assembly to induce eddy currents in at least one wellbore casing string.

3. The wellbore casing corrosion measurement tool of claim 2, wherein the energized selected components of the sensor assembly produce multiple radially outwardly extending electromagnetic fields that are symmetrically arranged about a circumference of the sensor assembly to induce eddy currents in at least one wellbore casing string.

4. The wellbore casing corrosion measurement tool of claim 1, wherein the detection of magnetic fields resulting from the eddy currents in the at least one wellbore casing string via the sensor assembly comprise detecting variations in magnetic fields resulting from the eddy currents in the at least one wellbore casing string via the sensor assembly, said variations in magnetic fields being indicative of a state of the at least one wellbore casing string.

5. The wellbore casing corrosion measurement tool of claim 1, wherein the sensor assembly comprises a plurality of sensor segments arranged into a segmented cylindrical shape such that a sensitivity axis of each sensor segment is aligned along a radial direction.

6. The wellbore casing corrosion measurement tool of claim 5, wherein the electromagnetic fields are formed by simultaneously energizing multiple opposing sensor segments.

7. The wellbore casing corrosion measurement tool of claim 5, wherein the symmetrically arranged electromagnetic fields are formed by simultaneously energizing multiple groups of opposing sensor segments.

8. The wellbore casing corrosion measurement tool of claim 1, wherein the control circuitry is further configured to change the selected components of the sensor assembly being energized over time to shift focus of the electromagnetic fields to thereby investigate different azimuthal sectors of the at least one wellbore casing string via the sensor assembly.

9. The wellbore casing corrosion measurement tool of claim 1, wherein:
the sensor assembly comprises multiple groups of sensor segments, each group configured to generate an electromagnetic field;
each of said groups of sensor segments includes first and second sets of sensor segments positioned radially opposite from one another about the circumference of the sensor assembly; and
magnetic fields generated by the first and second sets of sensor segments within each group when energized by the control circuitry have propagation directions oriented toward one another, forming a net magnetic field that extends from that group to form one of the electromagnetic fields that induces eddy currents in the at least one wellbore casing string.

10. The wellbore casing corrosion measurement tool of claim 9, wherein each of said groups of sensor segments includes first and second sets of sensor segments is positioned radially opposite from one another about the circumference of the sensor assembly in an antiparallel manner.

11. The wellbore casing corrosion measurement tool of claim 9, wherein the control circuitry is further configured to change which groups of sensor segments are energized over time, thereby shifting focus of the electromagnetic fields about a circumference of the sensor assembly to thereby investigate different azimuthal sectors of the at least one wellbore casing string via the sensor assembly.

12. The wellbore casing corrosion measurement tool of claim 1, wherein:
the sensor assembly comprises multiple groups of sensor segments, each group organized in a segmented cylindrical shape;
within each of the groups of sensor segments, the sensor segments alternate between having their sensitivity axes aligned along a circumferential direction, thereby forming a Halbach array configuration; and
the control circuitry is configured to energize transmitter coils at a selected sequence of the sensor segments within each group such that, due to the Halbach array configuration, the energized sequence creates a magnetic field extending from a central sensor segment of the sequence to thereby generate one of the electromagnetic fields that induces eddy currents in the at least one wellbore casing string.

13. The wellbore casing corrosion measurement tool of claim 12, wherein the control circuitry is further configured to change which groups of sensor segments are energized over time, thereby shifting focus of the electromagnetic fields about a circumference of the sensor assembly to thereby investigate different azimuthal sectors of the at least one wellbore casing string via the sensor assembly.

14. A method for assessing a condition of at least one wellbore casing string using a wellbore casing corrosion measurement tool, the method comprising:
deploying the tool into the at least one wellbore casing string, the tool having a sensor assembly;
energizing selected components of the sensor assembly to produce multiple electromagnetic fields that are arranged about a circumference of the sensor assembly to thereby induce eddy currents in the at least one wellbore casing string with the produced electromagnetic fields;
detecting a magnetic field generated by the eddy currents in the at least one wellbore casing string over time via at selected ones of the components of the sensor assembly;
recording the detected magnetic field; and
analyzing the recorded rate of change to determine potential conditions of the at least one wellbore casing string based on the detected rate of change.

15. The method of claim 14, wherein the energizing of the selected components of the sensor assembly produces multiple radially outwardly extending electromagnetic fields that are arranged about a circumference of the sensor assembly to thereby induce eddy currents in the at least one wellbore casing string with the produced magnetic fields.

16. The method of claim 15, wherein the energizing of the selected components of the sensor assembly produces multiple radially outwardly extending electromagnetic fields that are symmetrically arranged about a circumference of the sensor assembly to thereby induce eddy currents in the at least one wellbore casing string with the produced magnetic fields.

17. The method of claim 14, wherein the detection of the magnetic field comprises the detection of a rate of change in the magnetic field by the eddy currents in the at least one wellbore casing string over time via at selected ones of the components of the sensor assembly.

18. The method of claim 14, wherein the electromagnetic fields are formed by simultaneously energizing multiple opposing sensor segments of the sensor assembly.

19. The method of claim 14, wherein the electromagnetic fields are formed by simultaneously energizing multiple groups of opposing sensor segments of the sensor assembly.

20. The method of claim 14, further comprising changing the selected components of the sensor assembly being energized over time to shift focus of the electromagnetic fields about circumference of the sensor assembly to thereby investigate different azimuthal sectors of the at least one wellbore casing string.

21. The method of claim 14, wherein energizing the selected components of the sensor assembly comprises generating electromagnetic fields from multiple selected groups of sensor segments of the sensor assembly by causing each selected group to generate magnetic fields at first and second sets of sensor segments within that selected group to have propagation directions oriented toward one another, forming a net magnetic field that extends radially outwardly from that selected group to form one of the electromagnetic fields that induces eddy currents in the at least one wellbore casing string.

22. The method of claim 14, wherein energizing the selected components of the sensor assembly comprises generating electromagnetic fields from multiple selected groups of sensor segments of the sensor assembly by causing each selected group to energize transmitter coils at a chosen sequence of the sensor segments within that selected group arranged in a Hallbach array configuration to produce a magnetic field extending from a central sensor segment of the Hallbach array configuration, thereby creating one of the electromagnetic fields that induces eddy currents in the at least one wellbore casing string.
